(19) United States
(12) Patent Application Publication
(10) Pub. No.: US 2001/0042728 A1
(43) Pub. Date: Nov. 22, 2001

(54) WHEELED CRANE METHOD FOR TRANSPORTING SAME AND COUPLING TYPE VEHICLE

(75) Inventor: HIROSHI MIYAZAWA, AKASHI-SHI (JP)

Correspondence Address: OBLON SPIVAK MCCLELLAND, MAIER & NEUSTADT PC, FOURTH FLOOR, 1755 JEFFERSON DAVIS HIGHWAY, ARLINGTON, VA, 22202

(73) Assignee: Kabushiki Kaisha Kobe

(21) Appl. No.: 09/472,198

(22) Filed: Dec. 27, 1999

(30) Foreign Application Priority Data
Mar. 9, 1998 (JP) HEI 10-57145
Mar. 9, 1998 (JP) HEI 10-57144
Jun. 25, 1997 (JP) HEI 9-168703

(51) Int. Cl. B66C 23/72; B60P 3/06

(52) U.S. Cl. 212/195; 280/402

(57) ABSTRACT

A wheeled crane constructed in such a manner that when the crane is to be transported on a road, the whole of the crane is lifted upward on a front side thereof, allowing front wheels 4 of a lower travel body 1 float from a road surface, and a coupling frame 19 provided at a front end portion of the lower travel body 1 is coupled to a coupler 23 of a tractor T, thereby permitting the crane to travel by itself as a semi-trailer while ensuring a long wheel base, as well as a method for transporting the wheeled crane, and a coupling type vehicle.

### BACKGROUND OF THE INVENTION

1. Field of the Invention

The present invention relates to a large-sized wheeled crane which is restricted on road transport when it intends to travel by itself, as well as a method for transporting the wheeled crane, and a coupling type semi-trailer vehicle.

2. Description of the Related Art

Large-sized wheeled cranes of weights exceeding a certain limit, which are called all terrain cranes for example, are restricted by the vehicle restriction law which is mainly for the protection of bridges when they are transported on public roads, and thus cannot freely be transported on roads by traveling for themselves.

Heretofore, for avoiding such an inconvenience:

(a) when such a large-sized wheeled crane is to be transported on a road, it is disassembled into a lower travel body and an upper rotating structure and the lower travel body is transported by itself, while the upper rotating structure is transported separately by a trailer, or

(b) a route which is not in contravention of the vehicle restriction law is selected and the crane is transported up to a destination by itself.

However, in the above transporting method (a) which requires disassembly at every transport and assembly after arrival at a destination, a longer transportation time is required for such assembly and disassembly and an increase of the transportation cost results.

Also in the above method (b), not only the time and cost for transportation increase due to a roundabout transport to avoid passing through bridges, but also for a certain particular destination it is impossible to effect the transport.

As a method for transporting the wheeled crane in question on a road by itself while following the vehicle restriction law it may be effective to make the front, rear axle-to-axle spacing (wheel base) longer to disperse the load on each wheel over a wide span.

As a result, however, the vehicle length becomes larger, making it difficult to enter a narrow place or making it impossible to let the crane work in a narrow site, or it may become impossible for the crane to approach an object to be lifted, resulting in deterioration of the lifting capacity. Thus, the performance inherent in the crane is sacrificed.

In an effort to solve this problem there has been proposed such a technique as is disclosed in Japanese Utility Model Laid Open No. 56-144082, in which front wheels are constructed in a vertical movable manner, and during road transport,

a) a coupling portion for traction of the crane concerned is coupled to a coupler of a tractor, and

b) the front wheels are raised by a hydraulic cylinder and are floated from the road surface,

thereby substantially expanding the wheel base and in this state the whole of the crane is towed by the tractor.

According to this prior art, however, it is necessary to use a lift mechanism for raising and lowering the front wheels and therefore necessary to make a large-scaled reconstruction of a wheel suspension mechanism, resulting in that the structure of the same mechanism becomes complicated.

Thus, the wheel suspension mechanism not only becomes high in its cost but also becomes unsuitable as a wheel suspension mechanism for which reliability is particularly required.

### SUMMARY OF THE INVENTION

It is an object of the present invention to provide a wheeled crane capable of being transported on a road in a state of a long wheel base conforming to the vehicle restriction law without enlarging the wheel base of the crane itself and without requiring reconstruction of the wheel suspension mechanism, as well as a method for transporting the wheeled crane and a coupling type vehicle.

The present invention has adopted a method for transporting a wheeled crane, the wheeled crane comprising a lower travel body and an upper rotating structure mounted rotatably on the lower travel body, the upper rotating structure being provided with a boom capable of rise and fall and a cabin to be used for both crane work and traveling, the lower travel body being provided with axles at least in front and rear positions of a travel body frame and on both sides of the travel body frame, with wheels for self-traveling of the crane being mounted on both sides of the axles, wherein the lower travel body is coupled uncouplably to a coupler of a tractor while:

\mathring{1} the whole of the crane is lifted and the tractor-side wheels, out of the front and rear both-side wheels of the crane, float from a road surface,

\mathring{2} a crane load is partially borne by the tractor, and

\mathring{3} the lower travel body is maintained in a relatively rotatable state about a vertical axis, centered on the coupler of the tractor,

and in this state the wheeled crane is towed by the tractor and is thereby transported on the road.

### BRIEF DESCRIPTION OF THE DRAWINGS

FIG. 1 is a side view of a wheeled crane alone according to an embodiment of the present invention;

FIG. 2 is a side view of the wheeled crane, with a coupling frame set in a coupling position for road transport of the crane;

FIG. 3 is a side view showing the crane and a tractor which are being coupled together from the state of FIG. 2;

FIG. 4 is a side view showing a coupled state of the crane and the tractor;

FIG. 5 is a plan view thereof;

FIGS. 6A, 6B are schematic plan view for explaining the construction and operation of a coupled portion between the crane and the tractor; and

FIG. 7 is a side view showing a coupled state of a crane with a tractor with rear wheels of the crane being floated from a road surface, according to another embodiment of the present invention.

### DESCRIPTION OF THE PREFERRED EMBODIMENTS

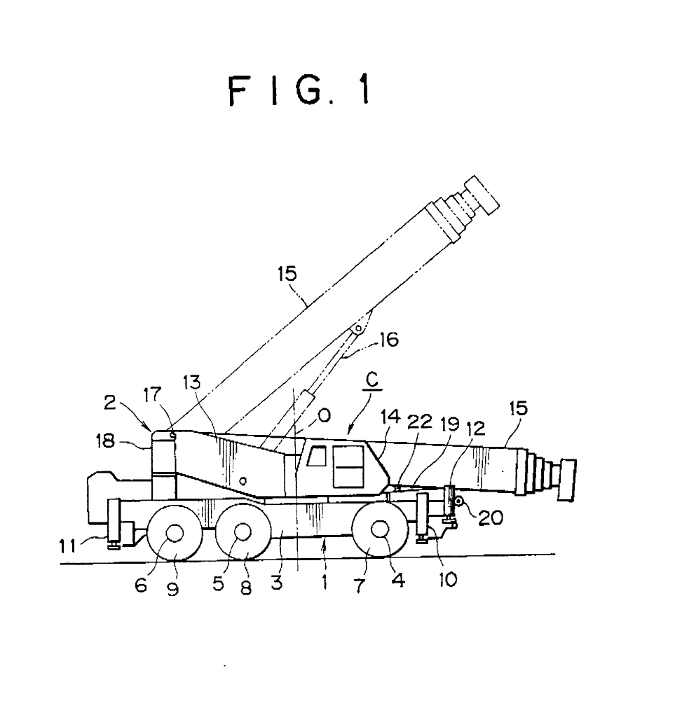

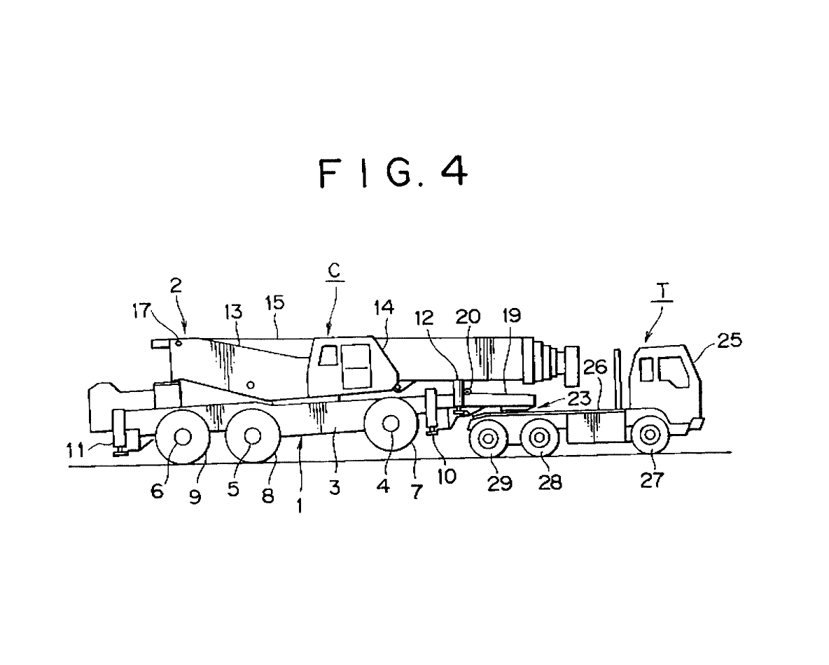

FIG. 1 shows a crane C alone, while FIG. 4 shows a coupling type vehicle with the crane C and a tractor T coupled together in road transport.

A basic construction of the crane (a large-sized wheeled crane called all terrain crane for example) C is the same as that of conventional like cranes, in which an upper rotating structure 2 is mounted on a lower travel body 1 so as to be swingable about a vertical axis O.

The lower travel body 1 has a travel body frame 3. One front axle 4 is disposed at a front end portion of the travel body frame 3 and two rear axles 5 and 6 are disposed at a rear portion of the travel body frame in a longitudinally spaced manner. Two front wheels 7 mounted respectively on both ends of the front axle 4 and two pairs of rear wheels 8 and 9 are mounted respectively at both ends of the rear axles 5 and 6.

At a front portion and a rear end portion of the travel body frame 3 are mounted outriggers 10 and 11 respectively so as to be protrudable in both horizontal and vertical directions. Further, at the front end portion of the same frame are mounted auxiliary outriggers 12 which are protrudable only vertically. During a crane work, the crane body is supported by the outriggers 10, 11 and 12.

The front outriggers 10 also serve as jacks to lift the lower travel body 1 so that the lower travel body is raised on its front side at the time of coupling thereof with the tractor T as will be described later.

On the other hand, the upper rotating structure 2 has a revolving frame 13, on which is mounted a cabin 14 to be used for both crane work and traveling (traveling of the crane alone). Further, a telescopic boom 15 is secured to the revolving frame 13 so that it can be raised and lowered about a boom foot pin 17 by means of a boom actuating cylinder 16.

The boom 15 is constructed so that with the crane C alone and in a maximum fallen condition thereon, the boom tilts forwardly downward as shown in the figure, while in a coupled state of the crane C with the tractor T the whole of the crane tilts forwardly upward and the boom 15 becomes substantially horizontal.

Numeral 18 denotes a counter weight which is attached to a rear end portion of the revolving frame 13 removably. In road transport of the crane C the counter weight 18 is removed from the revolving frame 13 and is conveyed separately.

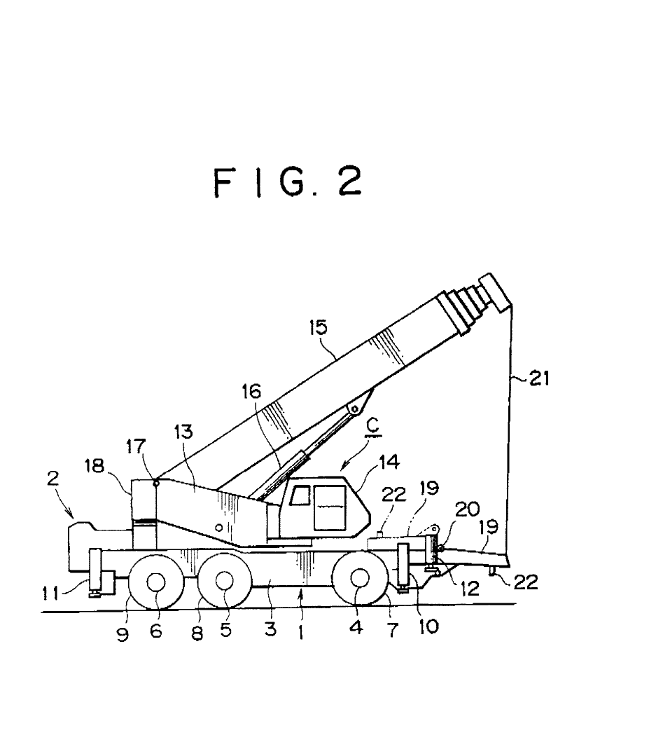

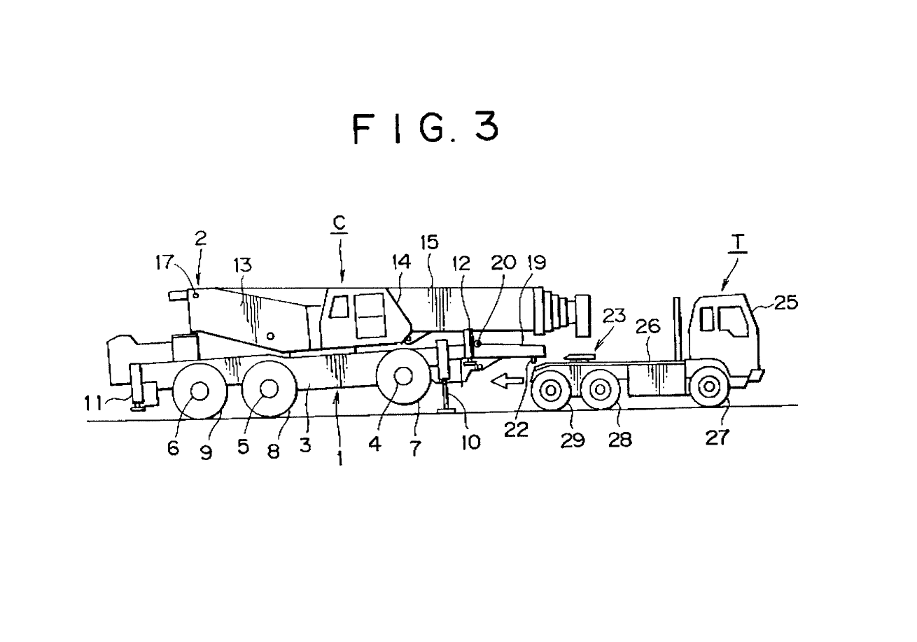

In the crane C, a coupling frame 19 as a coupling means for the tractor T is mounted through a hinge mechanism 20 to the front end portion of the travel body frame 3 so as to be pivotable between a stowing position in which the coupling frame 19 is put on a front upper surface of the travel body frame 3, as shown with a solid line in FIG. 1 and in phantom in FIG. 2 and a coupling position in which the coupling frame 19 turns approximate 180° forward around a horizontal axis from the said stowing position and projects forward of the travel body frame 3, as shown with a solid line in FIG. 2 and also shown in FIGS. 3 to 5.

With the crane C alone (uncoupled from the tractor T), the coupling frame 19 is set in the stowing position, while when the crane is coupled with the tractor T, the coupling frame 19 is set in the coupling position by utilizing the lifting function of the crane itself, as shown in FIG. 2. The numeral 21 in FIG. 2 denotes a hanger rope which is wound up and down by means of a winch (not shown).

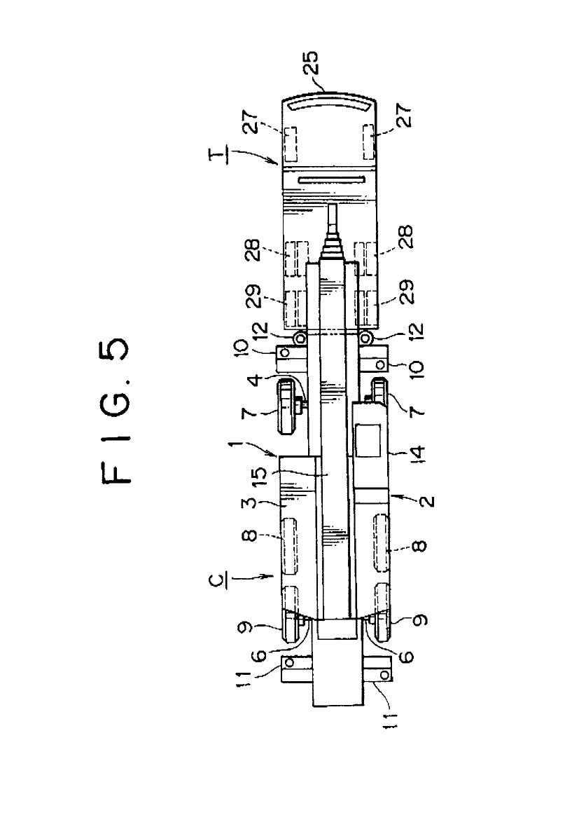

A king pin 22 is projected from a front end lower surface (the lower surface in the coupling position) of the coupling frame 19. By means of a known coupling mechanism comprising the king pin 22 and a coupler 23 provided on the tractor T side, the coupling frame 19 (crane C) and the tractor T are coupled together in a so-called semi-trailer fashion, that is, while the crane load is partially borne by the coupled portion, and so as to be relatively pivotable around a vertical axis, centered on a coupling point P (a coupler center shown in FIG. 5).

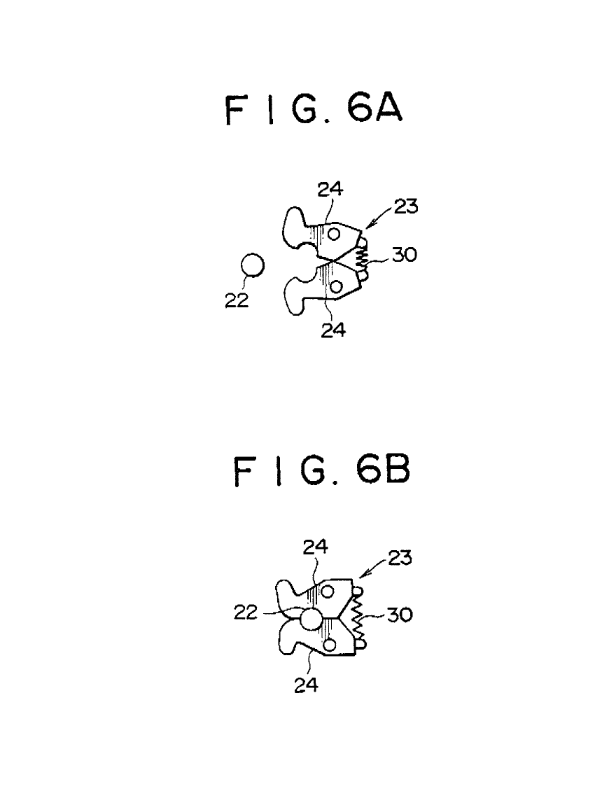

The coupler 23, as shown schematically in FIGS. 6A and 6B, comprises a pair of jaws 24 adapted to turn between an open position and a closed position and a jaw spring 30 which holds the jaws 24 in the closed position. When the king pin 22 is introduced between the jaws 24, the jaws are closed to lock (couple) the king pin 22 by the action of an operating mechanism (not shown).

The tractor T has a traction base 26 equipped with the coupler 23 behind a cabin 25 thereof, as known well. Below the cabin 25 and the traction base 26 are mounted front wheels 27 and rear wheels 28, 29.

During a crane work, the crane C is used alone (in an uncoupled state from the tractor T) as in FIG. 1. It runs in a work site through the front wheels 7 and rear wheels 8, 9 and performs the crane work while protruding the outriggers 10, 11 and 12 as necessary. At this time the coupling frame 19 is set in the stowing position as shown in the figure.

On the other hand, when the crane C is to be conveyed to the next work site by utilizing a public road after completion of the above crane work, it undergoes restrictions prescribed by the vehicle restriction law, and with the crane alone it is impossible to effect a road transport thereof along a route which includes a bridge.

In its road transport, therefore, the crane C is coupled to the tractor T in accordance with the following procedure.

\mathring{1} Set the coupling frame 19 to the coupling position, as shown in FIG. 2.

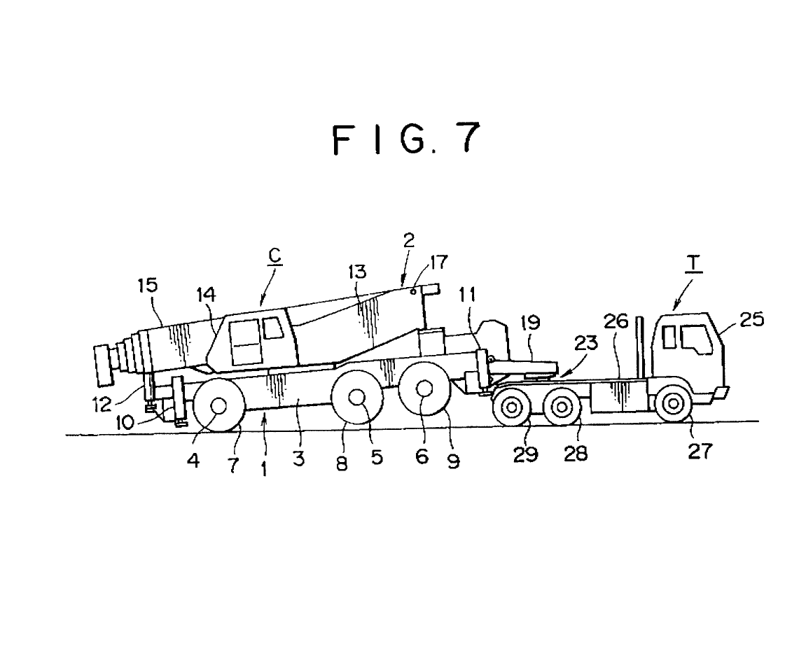

\mathring{2} Protrude the front outriggers 10 only in a vertical direction to lift the front portion of the crane, allowing the front wheels 7 to float from the ground, as shown in FIG. 7.

\mathring{3} Thereafter, cause the tractor T to retreat, which tractor is positioned so that its rear side faces the front side of the crane C, allowing the traction base 26 to get in under the travel body frame 3, and couple the king pin 22 and the coupler 23 with each other, as described previously.

\mathring{4} Subsequently, cause the front outriggers 10 to contract to constitute such a coupling type semi-trailer in which the crane C is coupled as a trailer to the tractor T.

In the state of such a coupling type vehicle, the counter weight 18 of the crane C is removed and conveyed separately.

While the crane alone travels, the front and rear wheels 7, 8 and 9 of the crane C are steered as steering wheels, while during transport by traction those wheels are locked unsteerably.

With the crane coupled as such a coupling type vehicle, the front wheels 7 of the crane float from the ground, so that the wheel base of the entire vehicle is enlarged in comparison with the case of the crane alone, whereby the load imposed on the ground is dispersed.

To be more specific, in a vehicle wherein the gross crane weight is 60 tons of which the weight of the counter weight is 12 tons, the tractor weight is 10 tons, and the total weight in a coupled state is 58 tons, 14.05 tons is imposed on each of the rear wheels 8 and 9 of the crane C, 20.0 tons is imposed on the coupled portion as the fifth wheel, 11.59 tons is imposed on the rearmost wheels 29 of the tractor, 11.69 tons on the tractor rear wheels 28, and 6.04 tons on the tractor front wheels. This load distribution conforms to the vehicle restriction law.

Thus, in this state the coupling type vehicle can travel on a bridge and hence the crane C can be conveyed by road transport along the shortest route up to a destination.

The overall height of the coupling type vehicle is determined by the boom 15. Since in this state the boom 15 becomes substantially horizontal as noted previously, it is possible to keep the overall vehicle height low.

After the transport, in accordance with the procedure reverse to the coupling procedure, the tractor T is uncoupled from the crane C, allowing the crane front wheels 7 to come into contact with the ground, the coupling frame 19 is set in the stowing position, and the counter weight 18 is mounted, whereby the original compact state of the crane C alone can be resumed.

(Modifications)

(1) Although in the above embodiment the front outriggers 10 originally provided in the crane C are utilized as jacks for lifting the front portion of the crane to let the front wheels 7 of the crane float at the time of coupling of the crane with the tractor T, jacks dedicated to lifting may be provided in the lower travel body 1 of the crane.

The front outriggers 10 or dedicated jacks as lifting means may be disposed behind the front wheels 7.

(2) Although in the above embodiment the coupling frame 19 is moved pivotally between the stowing position and the coupling position by utilizing the lifting function of the crane itself, the frame 19 may be moved between both positions by means of a hydraulic cylinder, or a combined mechanism of a hydraulic cylinder and links, or a gear mechanism provided with rack and pinion and using a hydraulic motor or the like as a drive source.

(3) Although in the above embodiment the coupling frame 19 is pivotally moved around a horizontal axis through the hinge mechanism 20 and is thereby shifted between the coupling position and the stowing position, the frame 19 may be turned laterally about a vertical axis and between such positions.

Or the frame 19 may be allowed to slide in a retractive manner between both positions.

Or the frame 19 may be attached to the front or the rear end portion of the travel body frame 3 removably and be moved between both positions.

(4) Although in the above embodiment the coupling frame 19 is provided at the front end portion of the travel body frame 3 and the crane C is towed by the tractor T so that the front portion of the crane faces the tractor, there may be adopted such a construction as shown in FIG. 7 in which the coupling frame 19 is provided at the rear end portion of the travel body frame 3 and the crane C is towed by the tractor T so that the rear portion of the crane faces the tractor.

(5) It is not always necessary for the coupling frame 19 to be stowed in such a manner that the whole thereof is completely received within the travel body frame 3 as in the above embodiment. The coupling frame 19 may be stowed so as to partially project outside the travel body frame 3 as long as this partial projection does not affect the narrow space enterability and the lifting capacity of the crane.

(6) The place where the coupling frame 19 is to be stowed is not limited to the upper surface of the travel body frame 3.

The coupling frame 19 may be stowed on the lower surface side of the travel body frame.

As described above, the whole of the crane is lifted so that the tractor-side wheels, out of the front and rear both-side wheels, float from the road surface, then in this state the lower travel body of the crane is coupled to the tractor uncouplably and so as to be relatively movable pivotally around a vertical axis, and in such a coupled state the wheeled crane is towed for road transport by the tractor. Thus, with the crane alone uncoupled from the tractor, the front-to-rear wheel spacing of the crane itself becomes a wheel base (a small wheel base), while during road transport the spacing between the crane axle located on the side opposite to the tractor side and a tractor axle substantially becomes a wheel base (a large wheel base).

Thus, during road transport, the crane can be conveyed in the form of a self-traveling semi-trailer while ensuring a long wheel base conforming to the vehicle restriction law, without enlarging the wheel base of the crane itself.

During road transport, therefore, it is possible to select a route of the shortest distance including a bridge, thereby shorten the transport time and greatly reduce the cost of transportation, and after the transport it is possible for the crane to revert to its compact shape and ensure its crane performance (narrow place enterability, narrow place workability, and lifting capacity).

Since the coupling of the crane with the tractor is done not by raising and lowering the wheels but in a state in which the whole of the crane is lifted, causing the wheels thereof located on the tractor side to float from the ground, it is not necessary to make any reconstruction for the wheel suspension mechanism, nor is there any fear of the suspension mechanism becoming complicated.

When all the wheels of the crane are in contact with the ground and the boom is in its maximum fallen condition, the boom tilts downward on its front side, the whole of the crane is lifted on its front side so that the boom becomes substantially horizontal, and in this state the crane is towed by the tractor, whereby the overall vehicle height in road transport can be kept low. Thus, an increase of the vehicular height does not occur although there is adopted the construction wherein the crane is coupled to the tractor while the entire crane tilts forwardly upward.

Moreover, since the crane is towed so that the front side thereof faces the tractor, there is no fear that the boom may project rearward, causing the whole of the coupling type vehicle longer, unlike the case where the rear side of the crane faces the tractor.

On the other hand, at least when the coupling frame is coupled to the tractor, the coupling frame assumes a projected state from the travel body frame to the tractor side, whereby an existing tractor adapted to be coupled to and separated from a known trailer through a similar coupling means can be utilized as it is as a crane tractor.

In this case, by mounting the coupling frame movably between a coupling position in which the coupling frame projects from the travel body frame to the tractor side and a stowing position in which the coupling frame is retracted to the travel body frame side, the coupling frame can be stowed to the travel body frame side in an uncoupled state of the crane and thus the travel body frame need not be extended despite the adoption of the construction wherein the crane is towed by the tractor in road transport. Therefore, it is not likely that the coupling frame may be an obstacle to crane works such as approaching an object to be lifted and entry into a narrow place.

Thus, there is no fear of deterioration of the narrow place enterability and the lifting capacity.

Moreover, since the coupling frame is mounted pivotably about a horizontal axis, the movement of the coupling frame between the coupling position and the stowing position can be done by the lifting function of the crane itself. That is, it is not necessary to use another crane or additional special moving means such as a hydraulic cylinder.

Further, by providing means for lifting the crane so that the tractor-side wheels of the crane float from the road surface when the crane is coupled to the tractor, it is not necessary to use another crane for lifting the crane or reconstruct the tractor for lifting the crane.

In this case, if jacks which function as outriggers in a crane work are mounted at the tractor-side end portion of the travel body frame, that is, if there is adopted a construction which permits the outriggers to also serve as such lifting means, it is possible to attain the rationalization of equipment.

I claim:

1. A method for transporting a wheeled crane, said wheeled crane comprising:
a lower travel body;
an upper rotating structure mounted rotatably on said lower travel body;
a boom provided in said rotatable superstructure so as to be capable of rise and fall;
a cabin provided for both crane work and traveling in said rotatable superstructure;
a travel body frame provided in said lower travel body;
a coupling means provided in said travel body frame;
axles provided at least in front and rear positions of said travel body frame and on both sides of the travel body frame; and
wheels for self-traveling of the crane, said wheels being provided on both sides of said axles,
said method comprising coupling said crane to a tractor through said coupling means and a coupler of the tractor uncouplably and in a relatively rotatable state about a vertical axis, centered on said coupler, while lifting the whole of the crane with respect to said coupler, allowing the tractor-side wheels out of the front and rear both-side wheels of the crane to float, thereby allowing a crane load to be partially borne by the tractor, and in this coupled state, towing and transporting the crane by the tractor.

2. A method for transporting a wheeled crane, said wheeled crane comprising:
a lower travel body;
an upper rotating structure mounted rotatably on said lower travel body;
a boom provided in said rotatable superstructure so as to be capable of rise and fall;
a cabin provided for both crane work and traveling in said rotatable superstructure;
a travel body frame provided in said lower travel body;
a coupling means provided in said travel body frame;
axles provided at least in front and rear positions of said travel body frame and on both sides of the travel body frame; and
wheels for self-traveling of the crane, said wheels being provided on both sides of said axles,
said method comprising coupling said crane to a tractor through said coupling means and a coupler of the tractor uncouplably and in a relatively rotatable state about a vertical axis, centered on said coupler, while lifting the whole of the crane wit respect to said coupler in an upwardly tilted state on a front side of the crane, allowing said boom to become substantially horizontal, said boom being adapted to tilt downward on a front side thereof in a grounded state of all said wheels and in a maximum fallen state of the boom, allowing front wheels of the crane to float from a road surface, thereby allowing a crane load to be partially borne by the tractor, and in this coupled state, towing and transporting the crane on the road by the tractor.

3. A wheeled crane comprising:
a lower travel body;
an upper rotating structure mounted rotatably on said lower travel body;
a boom provided in said rotatable superstructure so as to be capable of rise and fall;
a cabin provided for both crane work and traveling in said rotatable superstructure;
a travel body frame provided in said lower travel body;
a tractor coupling means for coupling a tractor and the crane with each other, said tractor coupling means being provided in said travel body frame;
axles provided at least in front and rear positions of said travel body frame and on both sides of the travel body frame;
wheels for self-traveling of the crane, said wheels being provided on both sides of said axles; and
said tractor coupled to the crane through said coupling means,
said wheeled crane being constructed in such a manner that when said lower travel body is coupled to a coupler of the tractor, the whole of the crane is lifted so that the tractor-side wheels out of said wheels float from a road surface, thereby allowing a crane load to be borne partially by the tractor, and in this state the crane can rotate relatively about a vertical axis, centered on said coupler.

4. A wheeled crane according to claim 3, wherein:
said boom is mounted so as to tilt downward on a front side thereof in a grounded condition of all said wheels of the crane and in a maximum fallen condition of the boom, and
said tractor coupling means is provided at a front end portion of said travel body frame, and in a coupled state of said lower travel body to said coupler of the tractor by said tractor coupling means, the whole of the crane tilt upward on a front side thereof, allowing said boom to become substantially horizontal, and the front wheels of the crane float from the road surface.

5. A wheeled crane according to claim 3, further including:
a coupling frame provided at an end portion of said travel body frame on the side where the crane is to be coupled to the tractor, said coupling frame being mounted so as to project from the travel body frame to the tractor side at least at the time of coupling to the tractor; and
a coupling member for the tractor, said coupling member being provided as said tractor coupling means in said coupling frame.

6. A wheeled crane according to claim 5, wherein said coupling frame is mounted for said travel body frame so as to be movable between a coupling position in which the coupling frame projects from said travel body frame to the tractor side and a stowing position in which the coupling frame retracts to the travel body frame side.

7. A wheeled crane according to claim 6, wherein in the coupling position for the tractor said coupling frame projects forward from a front end portion of said travel body frame.

8. A wheeled crane according to claim 6, wherein said coupling frame is mounted for said travel body frame so as to be rotatable about a horizontal axis between the coupling position and the stowing position.

9. A wheeled crane according to claim 3, further including:
a lifting means for lifting said lower travel body so that the tractor-side wheels of the crane float from the road surface at the time of coupling of the crane to the tractor.

10. A wheeled crane according to claim 9, wherein said lifting means comprises jacks provided at a tractor-side end portion of said travel body frame of said lower travel body, said jacks serving as outriggers which lift the entire crane from the ground in a crane work.

11. A coupling type vehicle comprising:
the wheeled crane described in claim 3, having the tractor coupling means; and
a tractor for towing said wheeled crane during transport of the crane,
said wheeled crane and said tractor being coupled together uncouplably through the tractor coupling means and a coupler of the tractor.

12. A coupling type vehicle comprising:
the wheeled crane described in claim 4, having the tractor coupling means; and
a tractor for towing said wheeled crane during transport of the crane,
said wheeled crane and said tractor being coupled together uncouplably through the tractor coupling means and a coupler of the tractor.

13. A coupling type vehicle comprising:
the wheeled crane described in claim 5, having the tractor coupling means; and
a tractor for towing said wheeled crane during transport of the crane,
said wheeled crane and said tractor being coupled together uncouplably through the tractor coupling means and a coupler of the tractor.

14. A coupling type vehicle comprising:
the wheeled crane described in claim 6, having the tractor coupling means; and
a tractor for towing said wheeled crane during transport of the crane,
said wheeled crane and said tractor being coupled together uncouplably through the tractor coupling means and a coupler of the tractor.

15. A coupling type vehicle comprising:
the wheeled crane described in claim 7, having the tractor coupling means; and
a tractor for towing said wheeled crane during transport of the crane,
said wheeled crane and said tractor being coupled together uncouplably through the tractor coupling means and a coupler of the tractor.

16. A coupling type vehicle comprising:
the wheeled crane described in claim 8, having the tractor coupling means; and
a tractor for towing said wheeled crane during transport of the crane,
said wheeled crane and said tractor being coupled together through the tractor coupling means and a coupler of the tractor.

17. A coupling type vehicle comprising:
the wheeled crane described in claim 9, having the tractor coupling means; and
a tractor for towing said wheeled crane during transport of the crane,
said wheeled crane and said tractor being coupled together through the tractor coupling means and a coupler of the tractor.

18. A coupling type vehicle comprising:
the wheeled crane described in claim 10, having the tractor coupling means; and
a tractor for towing said wheeled crane during transport of the crane,
said wheeled crane and said tractor being coupled together uncouplably through the tractor coupling means and a coupler of the tractor.
